(19) United States
(12) Patent Application Publication
(10) Pub. No.: US 2003/0211292 A1
(43) Pub. Date: Nov. 13, 2003

(54) Non-skid load protector

(76) Inventors: Arthur G. Malone, Woodland, WA (US); Kenneth A. Hooley, Molalla, OR (US)

Correspondence Address: Charles D. McClung, Chernoff, Vilhauer, McClung & Stenzel, LLP, 1600 ODS Tower, 601 S.W. Second Avenue, Portland, OR, 97204-3157, US

(21) Appl. No.: 10/141,589

(22) Filed: May 7, 2002

(51) Int. Cl. B32B 3/30

(52) U.S. Cl. 428/182

(57) ABSTRACT

A non-skid load protector includes a piece of corrugated paperboard that is coated on its top and bottom surfaces with a non-skid coating. The non-skid coating is 45-55% by volume water-based acrylic polymer, 0-3% surfactant, 20-40% anti-slip agent, 0-8% alcohol and 5-15% water.

### BACKGROUND AND SUMMARY OF THE INVENTION

This invention relates to a pad which is placed beneath a load being transported to prevent lateral movement of the load, and particularly to such a pad that is recyclable.

When large items, such as rolls of paper, are transported in railcars, or in other enclosed devices such as containers, truck trailers and the like, they are placed in contact with one another and in contact with the walls of the railcar, and any space between the rolls and the walls are filled. However, due to the size of paper rolls and the large forces which are generated in rail travel, the rolls still move laterally as the railcars accelerate, decelerate and travel around turns. As a result, spaces are eventually created between the rolls and, when this occurs, a sudden movement of the railcar will cause the rolls to shift into one another or into the walls of the railcar which causes damage to the rolls or to the walls.

To prevent this from occurring it is common to place the rolls on a thin rubber mat which prevents them from moving during transport. While rubber mats do prevent the rolls from moving, they have several shortcomings. First, rubber mats are expensive and because they often are only used once and then discarded, the cost of the mats is a factor in the transportation cost of the rolls. Second, because the mats are often only used once, the recipient of the rolls needs to dispose of the mats. Typically, there is a cost associated with the disposal of rubber since it cannot be placed with normal recyclables and often cannot be included with ordinary garbage. Finally, when the recipient of the paper rolls ships unusable rolls, or culls, back to the mill they came from, they will place them on the mats the paper was shipped to them on. When this occurs, the mats occasionally stick to the cull rolls of paper and when these cull rolls are recycled, the rubber mat goes with them and contaminates the resulting pulp.

The subject invention overcomes the shortcomings of the prior art rubber mats by providing a non-skid load protector made from a piece of corrugated paperboard having a non-skid coating on its upper and lower surfaces.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 is a perspective view showing the non-skid load protectors of the subject invention supporting paper rolls being transported in a boxcar.

FIG. 2 is a fragmentary perspective view of a non-skid load protector embodying the subject invention.

FIG. 3 is a cross-sectional view of the load protector shown in FIG. 2.

FIG. 4 is a cross-sectional view of another embodiment of the load protector.

FIG. 5 is a cross-sectional view of yet another embodiment of the load protector.

### DETAILED DESCRIPTION OF THE PREFERRED EMBODIMENT

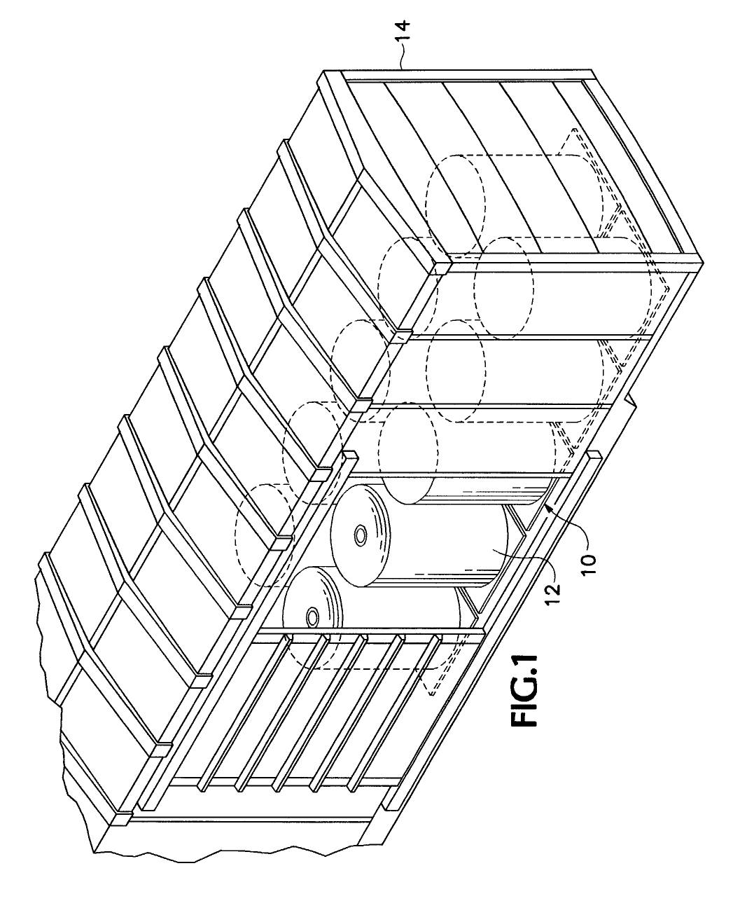

Referring to FIG. 1 of the drawings, a non-skid load protector 10 is placed beneath each paper roll 12 carried in a boxcar 14. While the drawings show paper rolls in boxcars, the load protector could be placed beneath any large object that is being transported, and it could be used in truck trailers or containers as well as railcars.

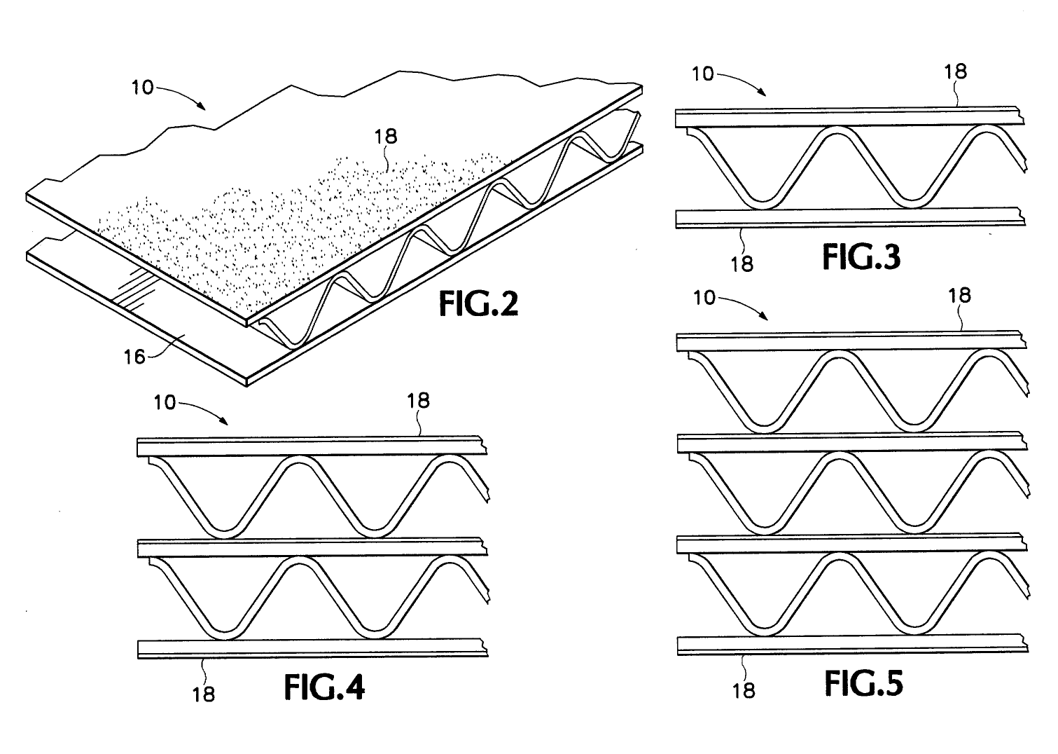

Referring now to FIGS. 2 through 5, the load protector is shown as a rectangular piece of corrugated paperboard 16 which is sized to fit under the desired load. It could have other shapes, however, depending on the load being placed on it. In addition, while a single load protector is shown for each roll of paper in the drawings, a single load protector could carry multiple rolls. Single wall L flute corrugated paperboard is a low-cost material that will work well for this purpose, FIG. 3, but it could be double wall, FIG. 4, or triple wall, FIG. 5, as well. In addition to being able to support the weight of loads of this type, and to withstand the sheer loads created by the lateral forces imparted by rail travel, corrugated paperboard provides some cushioning effect which protects the bottom surfaces of the load.

The pieces of corrugated paperboard 16 are coated top and bottom with a non-skid coating 18. The non-skid coating must be sticky enough to prevent the load carried by the protector from moving relative to the protector when subjected to loads such as those imparted by railcar travel. However, it must not be so soft that some of it will transfer to the material being transported. The coating also has to be easily applied to the piece of corrugated paperboard and dry quickly after it has been applied. Finally, the material must not contaminate the resulting pulp if a protector coated with it sticks to a roll of paper which is recycled.

A material that works well for this purpose includes 45-55% by volume of an acrylic polymer, preferably a soft acrylic polymer having a pH of 7.5-9.0 and a viscosity of 600-2,000 centipoises. A 600 series acrylic polymer works well for this purpose, and Lucidene 605, produced by Rohm & Haas, is optimal. The material also includes 0-3% by volume of a non-ionic type surfactant. The surfactant preferably is a finely refined petroleum-based alcohol, such as Ludox CLX which is produced by W. R. Grace. An anti-slip agent comprises 20-40% by volume of the material. An aqueous colloidal silicon dispersion made from silicon dioxide and ethylene glycol works well for this purpose. The curing speed of the material is controlled by the addition of between 0 and 8% by volume of a volatile solvent, such as aliphatic short-chain alcohol. Viscosity of the mixture is controlled by adding between 5 and 15% by volume of water to the material.

The coating can be applied by any conventional method, but it has been found that applying it with an airless sprayer gives the most even coverage without wasting material. The foregoing mixture does have some shelf life once mixed, but it should be used within a week or two weeks of mixing.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A non-skid load protector comprising:
(a) a sheet of corrugated paperboard having a top and bottom planar layer; and
(b) a non-skid coating which covers said planar layers.

2. The non-skid load protector of claim 1 wherein said corrugated paperboard is single-ply.

3. The non-skid load protector of claim 1 wherein said corrugated paperboard is double-ply.

4. The non-skid load protector of claim 1 wherein said corrugated paperboard is triple-ply.

5. The non-skid load protector of claim 1 wherein said non-skid coating comprises:
(a) between 45 and 55% by volume of a water-based acrylic polymer;
(b) between 0 and 3% by volume of a surfactant;
(c) between 20 and 40% by volume of an aqueous colloidal silica dispersion;
(d) between 0 and 8% by volume of a volatile solvent; and
(e) between 5 and 15% by volume of a non-reactive liquid.

6. The non-skid load protection of claim 5 wherein said polymer has a pH of 7.5-9.0 and a viscosity of 600-2,000 centipoises.

7. The non-skid load protector of claim 5 wherein said acrylic polymer is a 600 series polymer.

8. The non-skid load protector of claim 5 wherein said acrylic polymer is 605 polymer.

9. The non-skid load protection of claim 5 wherein said surfactant is non-ionic.

10. The non-skid load protector of claim 5 wherein said surfactant is a finely refined, petroleum-based alcohol.

11. The non-skid load protector of claim 5 wherein said solvent is an aliphatic short-chain alcohol.

12. The load protector of claim 5 wherein said non-reactive liquid is water.

13. The method of making a non-skid load protector comprising:
(a) providing a sheet of corrugated paperboard having a top and bottom planar surface;
(b) applying a non-skid coating onto said planer surfaces.

14. The method of claim 13 wherein the non-skid coating comprises:
(a) between 45 and 55% by volume of a water-based acrylic polymer;
(b) between 0 and 3% by volume of a surfactant;
(c) between 20 and 40% by volume of an aqueous colloidal silica dispersion;
(d) between 0 and 8% by volume of a volatile solvent; and
(e) between 5 and 15% by volume of a non-reactive liquid.

15. The method of claim 14 wherein said polymer has a pH of 7.5-9.0 and a viscosity of 600-2,000 centipoises.

16. The method of claim 14 wherein is said acrylic polymer is a 600 series polymer.

17. The method of claim 14 wherein said acrylic polymer is 605 polymer.

18. The method of claim 14 wherein said surfactant is non-ionic.

19. The method of claim 14 wherein said surfactant is a finely refined petroleum-based alcohol.

20. The method of claim 14 wherein said solvent is an aliphatic short-chain alcohol.

21. The method of claim 14 wherein said non-reactive liquid is water.

22. The method of claim 13 wherein the non-skid coating is sprayed onto said planar surfaces.
